(19) United States
(12) Patent Application Publication
(10) Pub. No.: US 2012/0092950 A1
(43) Pub. Date: Apr. 19, 2012

(54) LOW PRESSURE DROP BLENDER

(76) Inventors: Bertrand Michel Jean-Claude Colomb, Ruy (FR); Dennis Precourt, Carlsbad, CA (US); David L. Ruppert, Annandale, NJ (US); Paul Alan Stockman, Hillsborough, NJ (US)

(21) Appl. No.: 12/905,154

(22) Filed: Oct. 15, 2010

(51) Int. Cl. G05D 11/02; B01F 3/08; B01F 3/02; B01F 3/04

(52) U.S. Cl. 366/152.2

(57) ABSTRACT

A system and method for consistent and highly accurate blending of fluids; e.g. gases or liquids, without significant pressure drop. The system uses a flow meter to measure the amount of primary fluid being provided for mixing with the amount of diluent fluid controlled based on such measurement of the primary fluid amount.

### FIELD OF THE INVENTION

The present invention relates to a blender system that enables precise blending of gases or liquids with very low pressure drop.

### BACKGROUND OF THE INVENTION

Many industries require precise blends of fluids; e.g. gases or liquids, for use in manufacturing operations. It is often preferred to blend these fluids on site. For example, the manufacture of electronic devices, display devices and solar cell devices may require the use of fluorine gas in several manufacturing operations. Generally, fluorine is used in these operations in a gas mixture containing about twenty percent (20%) fluorine and a balance of argon or nitrogen.

Because fluorine is a very reactive gas and requires special handling if shipped, it is often desirable to produce fluorine on site using a fluorine generator, such as that available from Linde, Inc. that produces fluorine at a maximum pressure of 20 psig. This is a self imposed pressure limit put in place to mitigate safety concerns of using higher pressure and larger inventories of fluorine.

To meet the requirements of the manufacturing operation, the fluorine must generally be mixed with a diluent gas, e.g. argon or nitrogen, and is used as a replacement gas for cylinders or other containers used by the manufacturer. The mixtures are usually very specific to meet the particular requirements of the manufacturing operation. Therefore, it is necessary to be able to provide precise blends of the fluorine and diluent gas.

Known gas blenders, particularly those for precise blending, typically rely on mass flow controllers on both gas feed lines to provide the required specificity of the blend. These mass flow controllers include control valves that cause a substantial pressure drop in the delivery system. The 20 psig limit for fluorine generation coupled with the pressure drop from the mass flow controllers, as well as often long and complex delivery manifolds make the pressure drops caused by known gas blenders unacceptable for process tool demands (requiring up to 10 psig). In particular, known gas blenders will simply not work in these types of manufacturing application. Further, the control valves in the mass flow controllers are moving parts that can fail and require significant repair or replacement to maintain operation.

Therefore, there is a need in the art for improvements to systems for gas blending.

### SUMMARY OF THE INVENTION

The present invention provides a system and method for blending fluids; e.g. gases or liquids, without significant pressure drop. Blend accuracy is maintained by the system of the present invention while avoiding the pressure drop associated with known blending systems.

### BRIEF DESCRIPTION OF THE DRAWINGS

FIG. 1 is a schematic view of the blending system according to one embodiment of the present invention.

### DETAILED DESCRIPTION OF PREFERRED EMBODIMENTS

The present invention provides a system and method for blending two or more fluids without experiencing significant pressure drop. In particular, the present invention utilizes a near zero pressure drop run stream for the primary gas, such as fluorine, into which a diluent branch stream, such as argon or nitrogen, is mixed. Blend accuracy is assured according to the present invention by slaving a mass flow controller for the branch stream to a mass flow meter for the primary gas run stream.

Any problems with back streaming and retrograde mixing of gases are solved according to the present invention by using a series of high Cv process valves and activation/deactivation determined by fine-scaled pressure transducers.

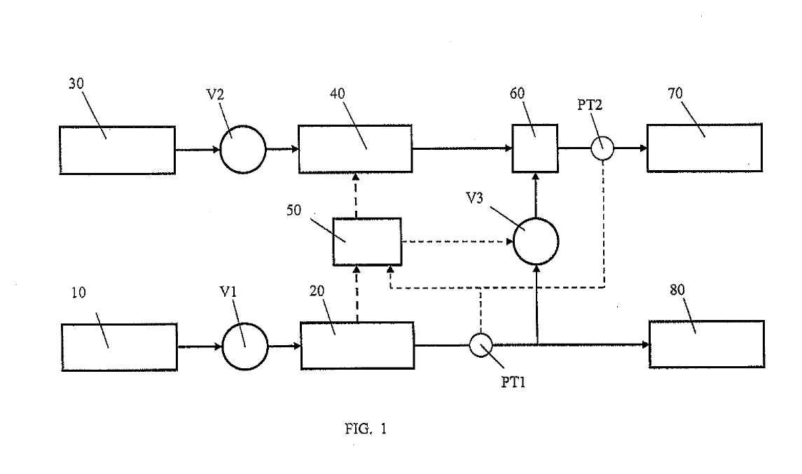

The present invention is more fully described with reference to FIG. 1 which is a schematic view of the blending system according to one embodiment of the present invention. As shown in FIG. 1, a primary gas source, such as a fluorine generator, 10 is connected to a primary gas mass flow meter 20 through a valve V1. A diluent gas source, such as argon or nitrogen, 30 is connected to a diluent gas mass flow controller 40 through a valve V2. The operation of the flow controller V2 is slaved to the operation of the flow meter 20 through a controller 50. In this manner the amount of diluent gas exiting the flow controller 40 can be precisely matched to that necessary to blend with the primary gas exiting the flow meter 20. In particular, primary gas from flow meter 20 passes through valve V3 and is mixed with the diluent gas exiting the flow controller 40 at mixing point 60. The pressure of the precisely mixed gas is maintained by controlling operation of the valve V3 by controller 50. In particular, controller 50 receives pressure information from pressure transducers PT1 and Pt2 and uses such information for the control of valve V3 as will be more fully described below. The mixed gas can be provided to process equipment 70 or waste gas can exit the system to waste facilities 80. The pressure drop for the primary gas from source 10 to the mixing point 60 is very small when operating according to the present invention, e.g. less than 1 psig; and preferably less than 0.3 prig.

In operation, the system of the present invention follows the general sequence described below. Valve V1 is opened and primary gas (such as fluorine) flows through the flow controller 20. In addition valve V2 is opened to begin the flow of diluent through the mass flow controller 40. The pressure differential across valve V3 is measured by pressure transducers PT1 and PT2 and that information is provided to controller 50. Because the flow controller 20 does not require a control valve there is very little pressure drop between the primary gas source 10 and valve V3. Therefore, pressure reading by pressure transducer PT1 when valve V3 is closed will be approximately the pressure of the primary gas as produced from primary gas source 10, e.g. for fluorine from a fluorine generator between 15 psig and 20 psig.

When process equipment 70 requires mixed gas from the system, gas will be drawn from the general area of mixing point 60. Initially, valve V3 will remain closed and pressure measured by pressure transducer PT2 will begin to fall with the difference in pressure between pressure transducer PT1 and pressure transducer PT2 rising. Pressure reading from the pressure transducers PT1 and PT2 are provided to the controller 50. The differential pressure based on the measured pressure values at pressure transducers PT1 and PT2 can be determined and then is compared with a predetermined pressure value by controller 50. When the pressure differential exceeds the predetermined pressure value, the controller 50 provides a signal for opening valve V3.

Upon opening valve V3, primary and diluent gases are combined and mixed at mixing point 60. As the process equipment 70 continues to require mixed gas, primary and diluent gas mixing continues and the differential pressure across valve V3 will remain at about the predetermined pressure value. When the process equipment 70 no longer needs mixed gas, the gases within the system will begin to reach equilibrium pressure and the pressure differential as measured by pressure transducers PT1 and PT2 will fall. When the pressure differential falls below a predetermined value as set by the controller 50, valve V3 is closed until more mixed gas is needed by the process equipment 70. In this manner, pressure drop across the system is minimized.

In a specific experiment using the system of the present invention dynamic blending of nitrogen with a running stream of 10.5 slm fluorine was carried out. The final product was a 20% fluorine in nitrogen blended gas stream. This mixing was accomplished with a pressure drop of less ant 0.2 psig.

The system of the present invention has several advantages over prior art blending systems. In particular, the system of the present invention can operate at very small differential pressures, e.g. less than 1 psig. This is significant improvement over the differential pressures required by prior art systems employing mass flow controllers. Further, the system of the present invention eliminates many moving parts by using a simple flow meter for measuring the amount of primary fluid entering the system. In particular, a mass flow controller having a control valve that is susceptible to failure as required in the prior art is not needed for the primary fluid supply according to the present invention. In addition, by controlling the amount of diluent fluid for mixing based on the amount of primary fluid measured by the flow meter, more consistent and accurate blending can be accomplished. It is a more specific advantage of the present invention that because very precise measurements of the primary fluid are provided to the controller 50, that slight start-up and shut-down discrepancies of the amount of diluent fluid needed for blending can be accounted for in subsequent cycles.

The system of the present invention can be varied in size to accommodate different flow rates ranging from 0.1 slm to 10,000 slm. Blend ratios can be any of interest, for example, blend ratios of 1% to 99% can be achieved using the system of the present invention. While fluorine has been specifically mentioned above, the system of the present invention can be used for any desired process fluid, such as those used for electronics, displays and solar device manufacture. Further, any diluent fluid can be used, such as argon, nitrogen, helium, hydrogen, air, oxygen, or methane.

In addition, more than one diluent fluid can be used, e.g. two or more fluid streams can be successively added to the process stream. Feed pressures for the primary fluid and diluent fluids can be varied to meet process demands, e.g. the primary fluid pressure may range from 0.3 psig to 200 psig and the diluent fluid pressure may range from 5 psig to 500 psig. Moreover, while gas blending has been described above, the present invention is not limited to gases, but rather may be used for mixing two or more liquid streams or combinations of gas and liquid streams.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is:

1. A method of blending fluids comprising:
delivering a primary fluid to an area downstream of a closed control valve through a flow meter;
measuring the amount of primary fluid delivered through the flow meter;
measuring the pressure of the primary fluid in the area downstream of the closed control valve;
delivering a secondary fluid to an area upstream of the closed control valve through a mass flow controller;
controlling the amount of secondary fluid delivered through the mass flow controller based on the measurement taken of the amount of primary fluid delivered through the flow meter;
measuring the pressure of the secondary fluid in the area upstream of the closed control valve;
comparing the measured pressures downstream and upstream of the closed control valve;
opening the control valve when the differential between the measured downstream pressure and the measured upstream pressure exceeds a predetermined amount; and
mixing the primary fluid and the secondary fluid in the area upstream of the control valve.

2. The method according to claim 1 wherein the fluids are gases.

3. The method according to claim 1 wherein the fluids are liquids.

4. The method according to claim 1 wherein the fluids are gases and liquids.

5. The method according to claim 1 wherein the differential between the measured downstream pressure and the measured upstream pressure is created by demand from process equipment fluidly connected with the area upstream of the control valve.

7. The method according to claim 5 wherein the process equipment is equipment for the manufacture of electronic devices, display devices or solar cell devices.

8. The method according to claim 1 further comprising mixing additional fluid with the primary fluid and secondary fluid.

9. The method according to claim 1 wherein the primary fluid is fluorine gas and the secondary fluid is a diluent gas.

10. The method of claim 9 wherein the fluorine gas is produced by a fluorine generator.

11. The method according to claim 9 wherein the diluent gas is argon, nitrogen, helium, hydrogen, air, oxygen or methane.

12. The method according to claim 1 wherein primary fluid is delivered to the area downstream of the control valve at a pressure of 0.3 to 200 psig.

13. The method according to claim 1 wherein secondary fluid is delivered to the area upstream of the control valve at a pressure of 5 to 500 psig.

14. The method according to claim 1 wherein the primary fluid experiences a pressure drop of less than 1 psig between delivery and mixing.

15. The method according to claim 14 wherein the pressure drop is less than 0.3 psig.

16. A system for blending fluids comprising:
a source for a primary fluid;
a flow meter fluidly connected with the source for the primary fluid;
a source for a secondary fluid;
a mass flow controller fluidly connected with the source for the secondary fluid;
a valve fluidly connected between the flow meter and the mass flow controller;
means to measure the pressure downstream of the valve;
means to measure the pressure upstream of the valve; and
control means for controlling the amount of secondary fluid delivered through the mass flow controller in response to the amount of primary fluid delivered through the flow meter, and for opening and closing the valve in response to the differential between the pressure measurements taken upstream and downstream of the valve.

17. The system according to claim 16 wherein the fluids are gases, liquids or a combination of gases and liquids.

18. The system according to claim 16 further comprising process equipment fluidly connected upstream of the valve.

19. The system according to claim 18 wherein the process equipment is equipment for the manufacture of electronic devices, display devices or solar cell devices.

20. The system according to claim 16 further including sources for additional fluids for blending with the primary fluid and secondary fluid.

21. The system according to claim 16 wherein the primary fluid is fluorine gas and the secondary fluid is a diluent gas.

22. The system according to claim 21 wherein the diluent gas is argon, nitrogen, helium, hydrogen, air, oxygen or methane.

23. The system according to claim 16 wherein the source of primary fluid is a fluorine generator.
